(19) United States
(12) Patent Application Publication
(10) Pub. No.: US 2019/0140820 A1
(43) Pub. Date: May 9, 2019

(54) Method for Block Cipher Enhanced by Nonce Text Protection and Decryption Thereof

(71) Applicant: Yinghwi Chang, New Taipei (TW)

(72) Inventor: Yinghwi Chang, New Taipei (TW)

(21) Appl. No.: 15/910,017

(22) Filed: Mar. 2, 2018

(30) Foreign Application Priority Data
Nov. 9, 2017 (TW) 106138824

(51) Int. Cl. H04L 9/06

(52) U.S. Cl. CPC H04L 9/0618; H04L 9/0631

(57) ABSTRACT

A method for block cipher enhanced by nonce text protection comprises: (a) providing a plain text data block; (b) inputting a corresponding nonce text based-on the plain text; (c) combining the plain text data with the nonce text to form a mix text with block length equal to block length of the plain text plus block length of the nonce text; and (d) utilizing a block encryption process to encrypt the mix text to generate a cipher text.

### BACKGROUND OF THE INVENTION

### Technical Field

The present invention relates to a method for block cipher protection, and more particularly, a method for block cipher enhanced by nonce text protection, applied to electronic device for digital data encryption and decryption.

### Description of Related Art

Block Cipher is a quite of crucial section in modern cryptography, which will be referred as “conventional block cipher” in this specification to distinguish the present invention.

Conventional block cipher is used for encrypting and decrypting a fixed block length, or as known as “conventional block cipher length” of plain text and cipher text, encrypted and decrypted by the same key, achieving by partial or complete function of an electronic device, more particularly, said partial or complete function achieving by hardware, software, or a combination of hardware and software. The need of plain text, cipher text and any temporal data are saved digitally at electronic device, which the unit of block length is bit.

The encryption and decryption of conventional block cipher is accomplished by a symmetric algorithm engine, where many symmetry algorithms are widely used today, such as Data Encryption Standard (DES), Advance Encryption Standard (AES) and so on. Take the conventional block cipher encryption processed by AES algorithm as an example, the block length of key may choose from 128-bit, 192-bit or 256-bit, wherein the 128-bit, encrypting 128-bit plain text as 128-bit cipher text, and, the conventional block cipher decryption processed by AES algorithm, decrypting 128-bit cipher text as 128-bit plain text, where the same key is used for encryption and decryption.

Block cipher mode of operation describes that how to encrypt the block cipher repeatedly, for those of plain texts and cipher texts greater than a fixed block length executing encryption and decryption. For instance, there are some common modes such as Electronic Codebook (ECB), Cipher Feedback (CFB), Output Feedback (OFB), Counter Mode (CTR) and so on. It would obey padding rule to complete the block length of plain text to be encrypted for integer multiple, if it is less than an integer multiple.

Among all the block cipher modes of operation, only the ECB mode is block data independent. Each block data of a message can be encrypted and decrypted independently. Other non-ECB modes are block data dependent. Once an error occurs at one encrypted data block, the coming encrypted data block can not be decrypted correctly. For instance, the data used in streaming media is not suitable to be encrypted by non-ECB mode.

A defect in ECB mode of the conventional block encryption process is that the same plain text data block would be encrypted to the same cipher text data block, thus, it could not secure the plain text data very well. In some of applications, this process could not provide strict data confidentiality and is generally not recommended for use in cryptographic protocols.

The use of non-ECB mode in the conventional block encryption process may provide better encryption confidentiality, yet it not only needs a key, but an initialization vector. In some of particularly applications, such as non-contact IC card authentication could not transmit the initialization vector through encryption way, therefore, it is impossible to use a more secure non-ECB mode, but only ECB mode.

Thus, according to the disadvantage of the prior arts, the present invention provides a novel method for block cipher enhanced by nonce text protection and decryption, which may exploit in ECB mode for overcoming the foregoing disadvantage of the conventional block cipher, furthermore, for non-ECB modes, it could increase the encryption confidentiality simultaneously.

### SUMMARY OF THE INVENTION

The present invention provides a method for block cipher enhanced by nonce text encryption, which may be applied in the block cipher operation mode of current approaches, wherein the basic principle is mixing the nonce text into plain text with enforcement before the encryption, resulting in disorder increasing, so that encryption confidentiality could be enhanced naturally.

A method for block cipher enhanced by nonce text encryption, the method is applied to an electronic device for executing data encryption, comprising: (a) providing a plain text, wherein the block length of the plain text is less than conventional block cipher; (b) inputting a corresponding nonce text based-on the plain text, where the block length of the nonce text plus the plain text must be equal to the block length of the conventional block cipher; (c) combining the plain text with the nonce text to form a mix text with block length equaling to block length of the conventional block cipher; and (d) utilizing a conventional block encryption process to encrypt the mix text to generate a cipher text.

According to one aspect of the present invention, said nonce text may generate by any kind of non-constant generators, wherein random number generator is one sort of them. Random number generator can produce higher disorder of the random number for nonce text than other non-constant ones. And using longer nonce text length can increase disorder in the mix text resulting in more encryption confidentiality of the cipher text.

According to one aspect of the present invention, wherein the combination of the plain text and corresponding nonce text is executed through a combiner.

The method in the present invention comprises the following step for decrypting data: (a) decrypting the cipher text which corresponding to the conventional block decryption process for restoring the mix text; (b) resolving the mix text into plain text and nonce text through a resolver.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a block diagram of a method for block cipher enhanced by nonce text encryption according to the present invention of an embodiment.

FIG. 2 illustrates a block diagram of a method for block cipher enhanced by nonce text decryption according to the present invention of an embodiment.

FIG. 3 illustrates a block diagram of a method for block cipher enhanced by nonce text encryption according to the present invention of another embodiment.

FIG. 4 illustrates a block diagram of a method for block cipher enhanced by nonce text decryption according to the present invention of another embodiment.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

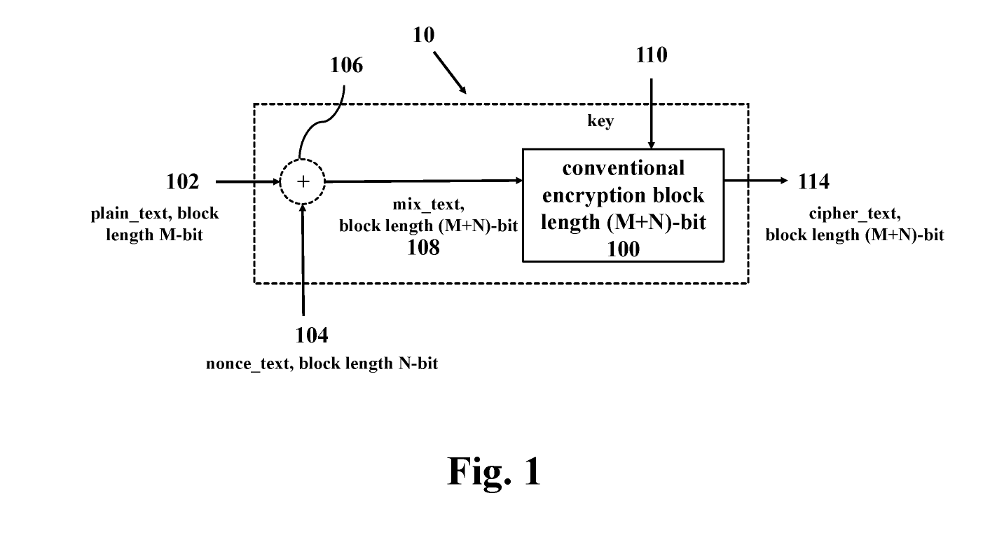

Please refer to FIG. 1, a method for block cipher enhanced by nonce text encryption according to the present invention, comprising: M-bit plain text 102 and N-bit nonce text 104 are combined to form (M+N)-bit mix text 108 by a combiner 106, wherein the nonce text 104 is produced through a random number generator outside, also, the mix text 108 is encrypted by a (M+N)-bit conventional encryption 100 to form a (M+N)-bit cipher text 114. In the block cipher step of mix text 108, adding an encryption key 110 for block cipher, the block length of encryption key 110 is chosen standing on the algorithm of conventional encryption 100, which could be referred as “key” in the present invention.

In FIG. 1, the logical relation between plain text 102, nonce text 104, mix text 108 could be described by IEEE standard Verilog as below:

mix_text[M+N−1:0]=(plain_text[0]<<A₀)|(plain_text[1]<<A₁)| . . .

(plain_text[M−1]<<A_{M-1})|(nonce_text[0]<<B₀)|(nonce_text[1]<<B₁)| . . .

(nonce_text[N−1]<<B_{N-1})

wherein the parameters A₀ ˜A_{M-1}, B₀˜B_{N-1} are chosen from the integers between 0 to (M+N−1), said logical relation also meet the following condition:

(1<<A₀)|(1<<A₁)| . . . (1<<A_{M-1})|(1<<B₀)|(1<<B₁)| . . . (1<<B_{N-1})=={(M+N){1′b1}}

The parameter A₀˜A_{M-1}, B₀˜B_{N-1} are chosen from the integers between 0 to (M+N−1) with M non-repetitive integers for arbitrary arrangement, then assigning to A₀˜A_{M-1} in order, also, arbitrary arrangement of the rest N integers are made, then assigning to B₀˜B_{N-1} in order.

According to one embodiment of the present invention, the combiner 106 in electrical device may be achieved by hardware, software, or a combination of hardware and software.

In FIG. 1, the method could be implemented by prior art except the combiner 106. Thus, the method for block cipher enhanced by nonce text encryption according to the present invention could be achieved by hardware, software, or a combination of hardware and software through the prior art.

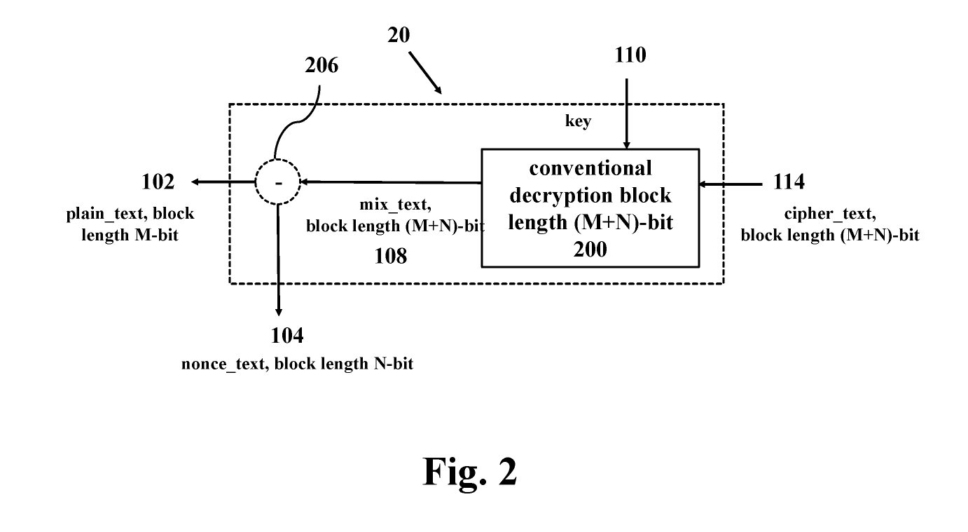

As illustrating in FIG. 2, the method for block cipher enhanced by nonce text decryption according to the present invention, comprising: the (M+N)-bit cipher text 114 is decrypted via a (M+N)-bit conventional decryption 200 to form a (M+N)-bit mix text 108, which then be resolved into M-bit plain text 102 and N-bit nonce text 104 by a resolver 206.

The above method of conventional encryption 100 and conventional encryption 200 are used for encrypting a fixed block length mix text 108 and decrypting a fixed block length cipher text 114 respectively, wherein the same key is used for encryption and decryption.

Please refer to FIG. 2, the logical relation between plain text 102, nonce text 104, mix text 108 could be described by IEEE standard Verilog as below:

plain_text[M−1:0]={mix_text[A_{M-1}],mix_text[A_{M-2}], . . . , mix_text[A₀] }

nonce_text[N−1:0]={mix_text[B_{N-1}],mix_text[B_{N-2}], . . . , mix_text[B₀]}

wherein the parameters A₀˜A_{M-1}, B₀˜B_{N-1} should equal to A₀˜A_{M-1}, B₀˜B_{N-1} which is chosen in the method for block cipher enhanced by nonce text encryption.

Similarly, the combiner 206 in electrical device may be achieved by hardware, software, or a combination of hardware and software.

As illustrating in FIG. 2, the method could be implemented by prior art except the combiner 206.

Thus, the method for block cipher enhanced by nonce text decryption according to the present invention could be achieved by hardware, software, or a combination of hardware and software through the prior art.

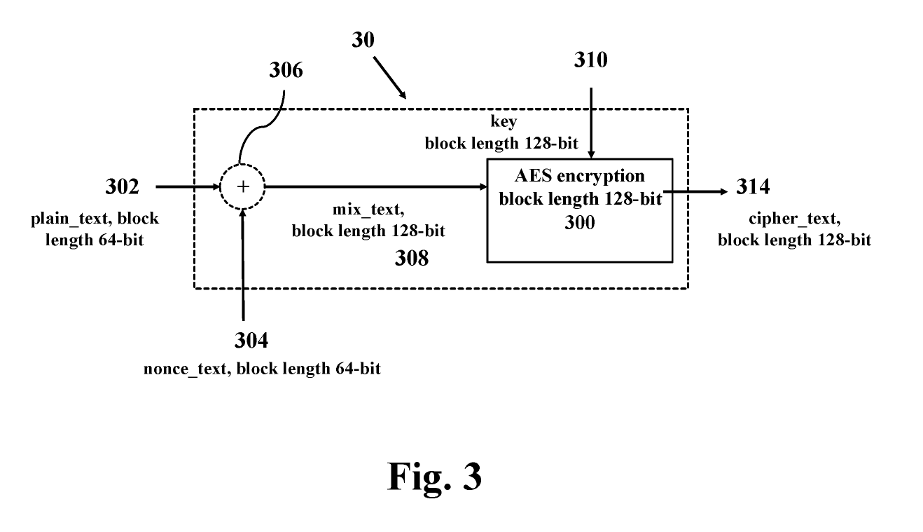

Take AES algorithm, block length 128-bit of encryption key 310, M=64, N=64 as an embodiment, the method for block cipher enhanced by nonce text encryption could be achieved, as illustrating in FIG. 3, comprising: 64-bit plain text 302 and 64-bit nonce text 304, combined to form 128-bit mix text 308 by a combiner 306, wherein the mix text 308 is encrypted through AES encryption 300 into 128-bit cipher text 314. In the block cipher step of mix text 308, adding a 128-bit encryption key 310 for block cipher.

According to above, integers are chosen from between 64˜127, then assigning to A₀˜A₃₁ in order; integers are chosen from between 0˜63, then assigning to B₀˜B₃₁ in order.

According to above, the logical relation between plain text 302, nonce text 304, mix text 308 could be described by IEEE standard Verilog as below:

mix_text[127:0]=(plain_text[0]<<64)|(plain_text[1]<<65)| . . .

(plain_text[63]<<127)|(nonce_text[0]<<0)|(nonce_text[1]<<1)| . . .

(nonce_text[63]<<63)

the above description could further simplified as below:

mix_text[127:0]={plain_text[63:0],nonce_text[63:0]}

Similarly, the combiner 306 in electrical device may be achieved by hardware, software, or a combination of hardware and software.

In FIG. 3, the method could be implemented by prior art except the combiner 306. Thus, the method for block cipher enhanced by nonce text encryption according to the present invention could be achieved by hardware, software, or a combination of hardware and software through the prior art.

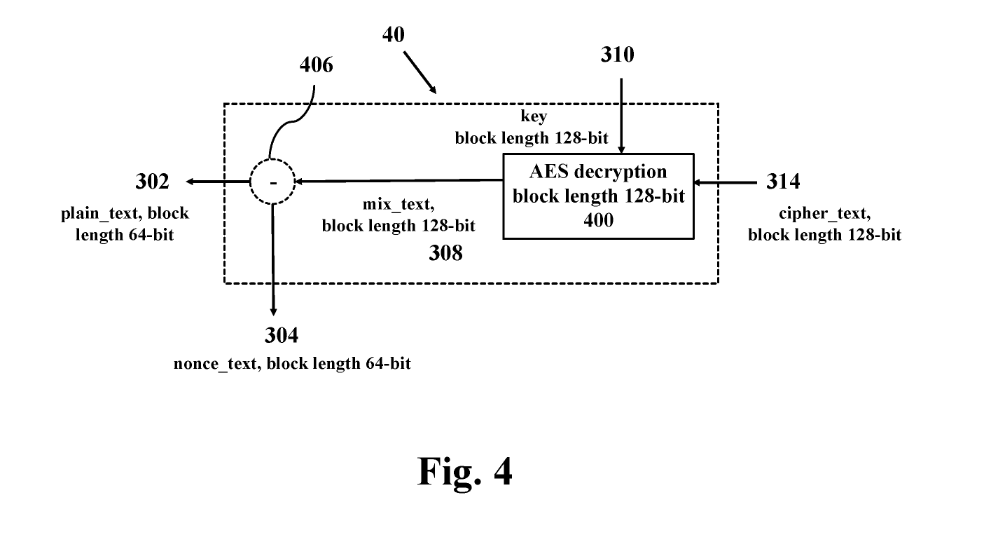

Take AES algorithm, M=64, N=64 as an embodiment, the method for block cipher enhanced by nonce text decryption of the present invention could be achieved, as illustrating in FIG. 4, comprising: A 128-bit cipher text 314, decrypted to 128-bit mix text 308 via AES decryption 400, which then be resolved into 64-bit plain text 302 and 64-bit nonce text 304 by a resolver 406.

Similarly, the logical relation between plain text 302, nonce text 304, mix text 308 could be described by IEEE standard Verilog as below:

plain_text[63:0]={mix_text[127],mix_text[126], . . . ,mix_text[64]}

nonce_text[63:0]={mix_text[63],mix_text[62], . . . ,mix_text[0]}

the above description could further simplified as below:

plain_text[63:0]=mix_text[127:64]

nonce_text[63:0]=mix_text[63:0]

Similarly, the resolver 406 in electrical device may be achieved by hardware, software, or a combination of hardware and software.

In FIG. 4, the method could be implemented by prior art except the resolver 406.

Thus, adopting AES algorithm, key block length 128-bit, M=64, N=64, the method for block cipher enhanced by nonce text decryption according to the present invention could be achieved by hardware, software, or a combination of hardware and software through the prior art.

The advantages of the present invention including:

1. A method for block cipher enhanced by nonce text encryption and may be applied to the conventional block cipher, the data confidentiality is reinforced since the enforcement adding the nonce text produced by non-constant generator.
2. Said non-constant generator could be a random number generator, which is art of mature for now on.
3. The use of the method in the present invention with block cipher in ECB mode, the combination of the nonce text resulting in two benefits. On the one hand, it improves the weakness of less data confidentiality in ECB mode, that is, it would result in different encrypt text for the same plain text encrypted in different times, on another hand, the advantage of different block ciphers independent on each other and could be decrypted independently would still be reserved.
4. It could increase the data confidentiality in streaming media data quite apparently for adopting the method of ECB mode with the present invention.
5. Also, the data confidentiality in non-contact IC card could increase quite apparently for adopting the method of ECB mode with the present invention as well.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A method for block cipher enhanced by nonce text, applied to an electronic device for executing data encryption, comprising:
(a) providing a plain text of M-bit with a first block length,
(b) inputting a nonce text of N-bit corresponding the plain text of M-bit, wherein the nonce text having a second block length,
(c) combining the plain text with the nonce text to form a mix text of (M+N)-bit with block length equal to the first block length of the plain text plus the second block length of the nonce text, and
(d) utilizing a block encryption process to encrypt the mix text to generate a cipher text with (M+N)-bit.

2. The method for block cipher encryption enhanced by nonce text of claim 1, wherein the nonce text is produced by a non-constant generator.

3. The method for block cipher encryption enhanced by nonce text of claim 2, wherein the non-constant generator comprises random number generator.

4. The method for block cipher encryption enhanced by nonce text of claim 1, wherein the method for block cipher further comprises adding a key.

5. The method for block cipher encryption enhanced by nonce text of claim 4, wherein block length of the key is chosen from the used of algorithm of conventional encryption according to encrypting fixed block length.

6. The method for block cipher encryption enhanced by nonce text of claim 1, wherein the method for block cipher encryption further comprises conventional encryption of fixed block length.

7. A method for block cipher decryption applied to an electronic device, where the block cipher is encrypted by the method of claim 1, comprising:
(a) utilizing a method for block cipher decryption corresponding to the method for block cipher encryption of claim 1 for decrypting the cipher text to form the mix text, and
(b) utilizing a resolver corresponding to the combining method of claim 1 for resolving the mix text into the plain text.

8. The method for block cipher decryption of claim 7, the block cipher is encrypted by the method of claim 1, wherein a key for the block cipher encryption and decryption are the same.

9. The method for block cipher decryption of claim 8, the block cipher is decrypted by the method of claim 1, wherein block length of the key is chosen from the used of algorithm of conventional encryption according to encrypting fixed block length.
